(19) United States
(12) Patent Application Publication
(10) Pub. No.: US 2025/0010770 A1
(43) Pub. Date: Jan. 9, 2025

(54) CHILD SAFETY SEAT

(71) Applicant: Wonderland Switzerland AG, Steinhausen (CH)

(72) Inventor: Guanghui ZHAO, Steinhausen (CH)

(73) Assignee: Wonderland Switzerland AG, Steinhausen (CH)

(21) Appl. No.: 18/709,304

(22) PCT Filed: Nov. 14, 2022
(86) PCT No.: PCT/EP2022/081792

§ 371 Date: May 10, 2024

(30) Foreign Application Priority Data
Nov. 12, 2021 (CN) 202111342785.7

(51) Int. Cl. B60N 2/28

(52) U.S. Cl. CPC B60N 2/2884

(57) ABSTRACT

The present application relates to a child safety seat, which includes a seat body, a seat belt, and a first barrier. The seat body defines a seating space. The seat belt is disposed on the front of the seat body and on the rear of the seat body. The first barrier is disposed on the rear of the seat body. The seat belt abuts against the first barrier, and the first barrier is configured to prevent the seat body from being deformed.

### CROSS REFERENCE TO RELATED APPLICATION

This application claims the benefit of Chinese Patent Application No. 2021113427857, filed on Nov. 12, 2021, the entire content of which is incorporated herein in its entirety.

### TECHNICAL FIELD

The present application relates to the technical field of child carrier, in particular, to a child safety seat.

### BACKGROUND

At present, the child safety seat on the market, in the event of an accident such as an impact or a car emergency braking, is often prone to generate a certain acceleration due to its own inertia or an impact force received, resulting in a certain displacement of the head of a child seated on the safety seat. However, if the child's head is displaced too much, it might possibly cause an injury to the child's body.

### SUMMARY

A child safety seat is provided. The child safety seat includes a seat body defining a seating space, a seat belt disposed on the front of the seat body and on the rear of the seat body, and a first barrier disposed on the rear of the seat body. The seat belt abuts against the first barrier, and the first barrier is configured to prevent the seat body from being deformed.

In the above-described child safety seat, the seat belt is disposed on the front of the seat body and the rear of the seat body to secure the child in the seating space. In addition, the first barrier is disposed on the rear of the seat body, the seat belt abuts against the first barrier, and the first barrier is configured to prevent the seat body from being deformed. In this way, it can be avoided that, when a vehicle is in an accident such as an impact or an emergency braking, the seat body is pulled and dragged under the impact force of the seat belt to be deformed such that the length of the seat belt in the seating space is increased to allow the child's head to be displaced upward too much, thereby effectively reducing the injury to the child's body.

In one of the embodiments, the seat body includes a seat base and a backrest. The seat base and the backrest enclose to define the seating space. The seat belt is disposed on the front of the seat base and the backrest and on the rear of the seat base and the backrest.

In one of the embodiments, the first barrier is disposed on the rear of the seat base to enable the seat belt to be spaced apart from the rear of the seat base.

In one of the embodiments, the first barrier has a hardness greater than that of the seat base.

In one of the embodiments, the first barrier has a shape of rod, and is at least partially embedded in the rear of the seat base.

In one of the embodiments, the seat belt includes a first connecting section and a second connecting section. The first connecting section has a first end and a second end. The first end is disposed on the rear of the backrest and the second end is disposed on the front of the backrest. The second connecting section passes around the seat base and has a third end and a fourth end. The third end is disposed on the front of the seat base, and the fourth end is connected to the first end.

In one of the embodiments, the child safety seat further includes a limiting member pivotably connected the first barrier and configured to limit the seat belt to the rear of the seat body.

In one of the embodiments, the child safety seat further includes a limiting member configured to limit and fix the seat belt to the rear of the backrest, and a fixing rod fixed on the rear of the backrest, and having the limiting member pivotably connected thereto.

In one of the embodiments, the limiting member includes a limiting portion configured to press the seat belt against the rear of the backrest.

In one of the embodiments, the limiting portion includes a plurality of limiting teeth.

In one of the embodiments, the backrest is provided with a perforation hole, the seat belt passes around the front of the backrest from the rear of the backrest through the perforation hole, and the fixing rod is arranged opposite to the perforation hole.

In one of the embodiments, the child safety seat further includes a second barrier. The second barrier is transversely disposed on the rear of the backrest and is configured to prevent the child safety seat from being deformed.

In one of the embodiments, the rear of the backrest is provided with a first mounting rib and a second mounting rib disposed on two opposite sides thereof, and two ends of the second barrier are fixed on the first mounting rib and the second mounting rib, respectively.

In one of the embodiments, the second barrier has a circular tubular structure.

In one of the embodiments, the circular tubular structure has an outer diameter of 12 mm to 13 mm; the circular tubular structure has a thickness of 1 mm to 1.6 mm.

In one of the embodiments, the child safety seat further includes a clamping member disposed on the front of the backrest and configured to clamp and fix an on-board safety belt of a vehicle.

A child safety seat includes a seat body including a seat base and a backrest connected to each other to define a seating space, and a second barrier fixed on the backrest and configured to prevent the backrest from being deformed.

In one of the embodiments, the second barrier is transversely disposed on the rear of the backrest.

In one of the embodiments, the rear of the backrest is provided with a first mounting rib and a second mounting rib disposed on two opposite sides thereof, and two ends of the second barrier are fixed on the first mounting rib and the second mounting rib, respectively.

In one of the embodiments, the second barrier has a circular tubular structure.

In one of the embodiments, the circular tubular structure has an outer diameter of 12 mm to 13 mm; the circular tubular structure has a thickness of 1 mm to 1.6 mm.

In one of the embodiments, the child safety seat further includes a clamping member disposed on a side of the backrest facing the seating space and configured to clamp and fix an on-board safety belt of a vehicle.

### BRIEF DESCRIPTION OF THE DRAWINGS

FIG. 1 is a schematic view of a child safety seat according to a first embodiment of the present application;

FIG. 2 is a schematic view of the child safety seat shown in FIG. 1 seen from another viewpoint;

FIG. 3 is a schematic view of the child safety seat shown in FIG. 1 seen from yet another viewpoint, in which a seat belt is omitted;

FIG. 4 is an enlarged view of a portion A in FIG. 3;

FIG. 5 is a schematic view of a child safety seat according to a second embodiment of the present application;

FIG. 6 is a schematic view of the child safety seat shown in FIG. 5 seen from another viewpoint;

FIG. 7 is a schematic view of the child safety seat shown in FIG. 5 seen from yet another viewpoint;

FIG. 8 is a schematic view of a child safety seat according to a third embodiment of the present application;

FIG. 9 is a partial cross-sectional view of a side of the child safety seat shown in FIG. 8;

FIG. 10 is a schematic view of a limiting member shown in FIG. 8;

FIG. 11 is a schematic view of a second barrier shown in FIG. 6; and

FIG. 12 is a schematic view of a child safety seat according to a fourth embodiment of the present application.

Illustration for reference signs:

10, child safety seat; 100, seat body; 110, seating space; 120, seat base; 121, accommodation portion; 130, backrest; 131, perforation hole; 132, first mounting rib; 133, second mounting rib; 200, seat belt; 210, first connecting section; 211, first end; 212, second end; 201, first shoulder belt; 202, second shoulder belt; 220, second connecting section; 222, fourth end; 230, third connecting section; 231, fifth end; 232, sixth end; 300, first barrier; 410, first connecting member; 420, second connecting member; 510, limiting member; 511, limiting portion; 511a, limiting teeth; 512, pivoting portion; 520, fixing rod; 600, second barrier; 700, clamping member; and 20, on-board safety belt.

### DETAILED DESCRIPTION OF THE EMBODIMENTS

In order to make the objects, technical solutions, and advantages of the present application become more apparent, the present application will be further described in detail below with reference to the accompanying drawings and specific embodiments. It should be understood that the specific embodiments described herein are only used to explain the present application, and do not limit the protection scope of the present application.

It should be noted that when an element is referred to as being “fixed to” another element, it can be directly on the other element or an intermediate element may also be present. When an element is referred to as being “connected to” another element, it can be directly connected to another element or an intermediate element may also be present at the same time. The terms “vertical”, “horizontal”, “left”, “right”, and similar expressions used herein are for illustrative purposes only.

Unless otherwise defined, all technical and scientific terms used herein have the same meaning as commonly understood by one of ordinary skill in the art to which the present application belongs. The terms used herein in the description of the present application are for the purpose of describing specific embodiments only, and are not intended to limit the present application. As used herein, the term “and/or” includes any and all combinations of one or more of the associated listed items.

### First Embodiment

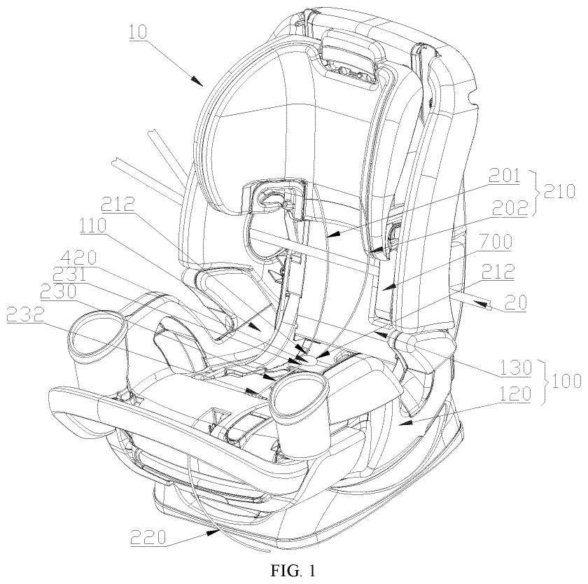

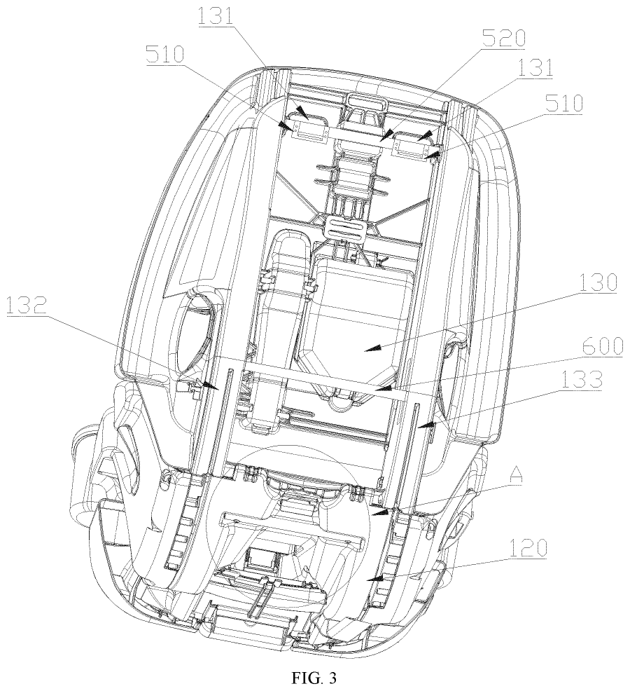

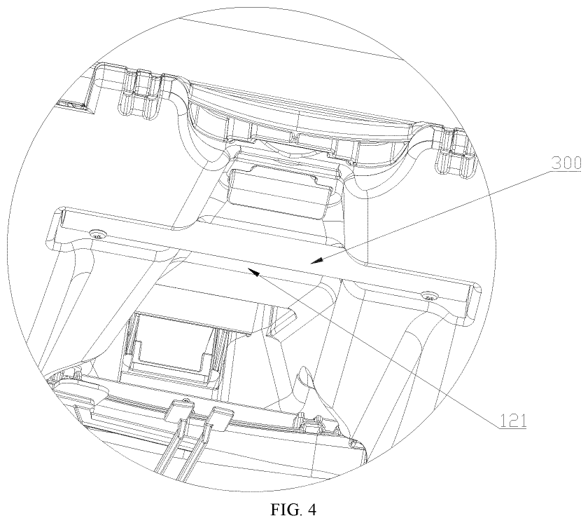

As shown in FIGS. 1 to 4, a first embodiment of the present application provides a child safety seat 10, which includes a seat body 100, a seat belt 200, a first barrier 300, a limiting member 510, a second barrier 600, and a clamping member 700.

Specifically, as shown in FIG. 1, the seat body 100 includes a seat base 120 and a backrest 130 that are connected to each other to define a seating space 110. A child may seat in the seating space 110. The seat base 120 serves to support the buttocks of the child, and the backrest 130 serves to support the back of the child. In this embodiment, the seat base 120 and backrest 130 are made of plastic material, but not limited to this.

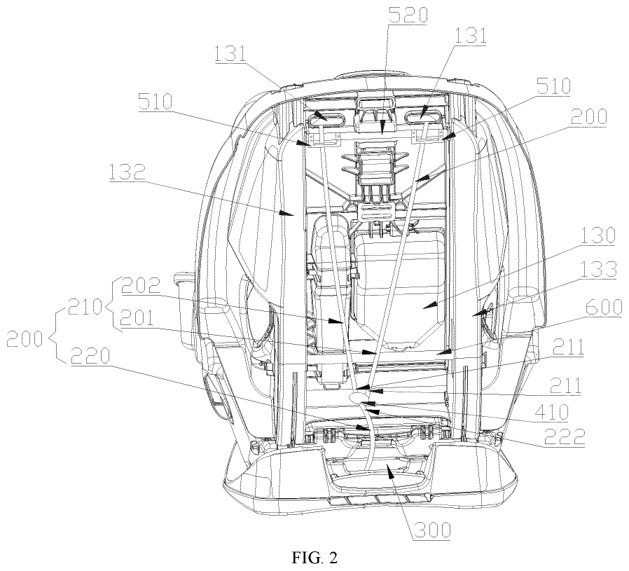

As shown in FIGS. 1 and 2, the seat belt 200 includes a first connecting section 210, a second connecting section 220, and a third connecting section 230. The first connecting section 210 has a first end 211 and a second end 212. The first end 211 is disposed on the rear of the backrest 130, and the second end 212 is disposed on the front of the backrest 130, so that the first connection section 210 may secure the child to the seating space 110. In this embodiment, the child safety seat 10 further includes a first connecting member 410 and a second connecting member 420. The first connecting member 410 is disposed on the rear of the backrest 103. The second connecting member 420 is disposed in the seating space 110. In the embodiment shown in FIGS. 1 and 2, the first connecting section 210 includes a first shoulder belt 201 and a second shoulder belt 202 that are arranged side by side. The first end 211 of the first shoulder belt 201 and the first end 211 of the second shoulder belt 202 are both fixed to the first connecting member 410, the second end 212 of the first shoulder belt 201 and the second end 212 of the second shoulder belt 202 are both connected to the second connecting member 420, so that the first shoulder belt 201 and the second shoulder belt 202 pass around the rear of the backrest 130 into the seating space 110. In this way, the first shoulder belt 201 and the second shoulder belt 202 respectively secure the child's shoulders to the child safety seat 10. The second connecting section 220 has a third end (not shown in the drawings) and a fourth end 222. The third end is disposed on the front of the seat base 120. The fourth end 222 is connected to the first ends 211 of the two shoulder belts to the second connecting member 420. Thus, the second connecting section 220 passes around the front of the seat base 120 and the rear of the seat base 120. The third connecting section 230 has a fifth end 231 and a sixth end 232. The fifth end 231 is connected to the second connecting member 420. The sixth end 232 is disposed inside the seat base 120 through being connected to a buckle (e.g., a slide buckle). In this way, the seat belt 200 can secure the child in the seating space 110 to the child safety seat 10. In this embodiment, the first connecting member 410 is, for example, a five-way safety buckle, and the second connecting member 420 is, for example, a woven metal buckle. Of course, in other embodiments, the first connecting member 410 and the second connecting member 420 can also be in other forms. Moreover, in other embodiments, the seat belt 200 may also be configured in other manners.

It should be understood that the “front” and “rear” described herein are specifically referenced to the seating space 110. For example, the front of the backrest 130 refers to a side of the backrest 130 facing the seating space 110, and the rear of the backrest 130 refers to a side of the backrest 130 facing away from the seating space 110, and so on.

As shown in FIGS. 2 to 4, the first barrier 300 is fixed to the rear of the seat base 120. Specifically, the seat base 120 is provided with an elongated accommodating portion 121, and the first barrier 300 is mounted in the accommodating portion 121 by a fastener such as a screw. The seat belt 200 abuts against the first barrier 300, and the first barrier 300 is configured to prevent the seat base 120 from being deformed. In this way, it can be avoided that, when a vehicle is in an accident such as an impact or an emergency braking, the seat base 120 is pulled and dragged under the impact force of the seat belt 200 to be deformed such that the length of the seat belt 200 in the seating space 110 is increased to allow the child's head to be displaced upward too much, thereby effectively reducing the injury to the child's body. Of course, in other embodiments, the first barrier 300 may also be fixed on the rear of the backrest 130, the seat belt 200 abuts against the first barrier 300, and the first barrier 300 is configured to prevent the backrest 130 from being deformed. The child safety seat can effectively reduce the degree of upward displacement of the child's head in the child safety seat when an accident occurs, so as to avoid causing an injury to the child's body.

Further, the first barrier 300 may protrude from the rear of the seat base 120 so that the seat belt 200 is spaced apart from the rear of the seat base 120. In this way, the seat belt 200 is not directly in contact with the seat base 120, but is directly in contact with the first barrier 300. When the vehicle encounters an accident such as an impact or an emergency braking, the first barrier 300 can receive the impact force applied to the seat belt 200, so that the seat base 120 is protected from being deformed by the seat belt 200, and the portion of the seat belt 200 in the seating space 110 is prevented from being lengthened, thereby reducing the degree of upward displacement of the child' head.

Further, the first barrier 300 has a hardness greater than that of the seat base 120. In this way, the first barrier 300 is disposed on the seat base 120, so that the structural strength of the seat base 120 can be increased. When the vehicle is in an accident such as an impact or an emergency braking, the seat base 120 is not easily deformed through pulling and dragging by the seat belt 200, and the portion of the seat belt 200 in the seating space 110 can be prevented from being lengthened, thereby reducing the degree of upward displacement of the child' head.

Optionally, the first barrier 300 has a shape of rod, and is completely embedded or partially embedded in the rear of the seat base 120. In this embodiment, the first barrier 300 is partially embedded in the rear of the seat base 120, such that the seat belt 200 directly abuts against the first barrier 300, and the seat belt 200 is spaced apart from the rear of the seat base 120.

Further, as shown in FIG. 2, the limiting member 510 is configured to limit and fix the seat belt 200 to the rear of the backrest 130. In this way, the length of the portion of the seat belt 200 in the seating space 110 can be further limited, and the portion of the seat belt 200 in the seating space 110 can be prevented from being pulled over-long when the vehicle encounters an accident such as an impact or an emergency braking, thereby reducing the degree of upward displacement of the child's head.

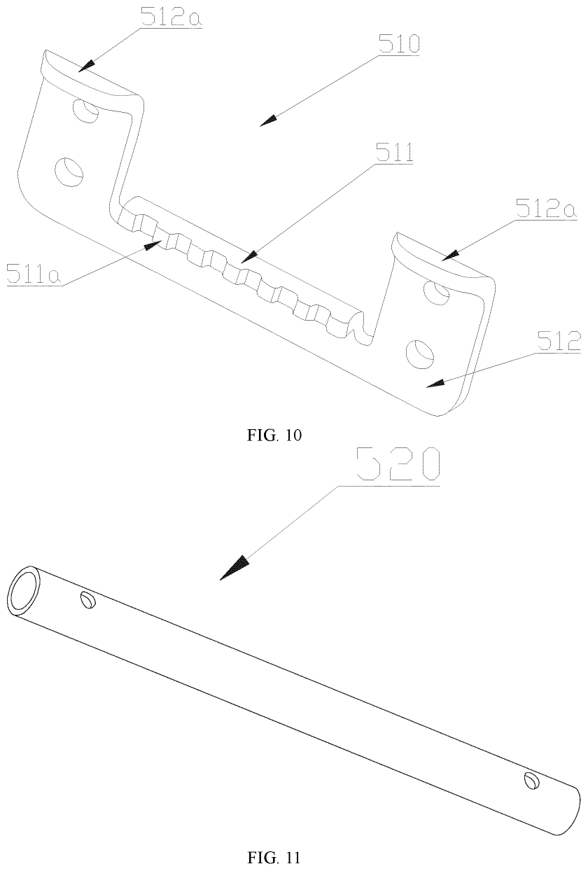

Further, in one embodiment, the first barrier 300 and the second barrier 600 may also have at least one limiting member 510 disposed thereon. In another embodiment, as shown in FIGS. 2 and 10, the child safety seat 10 further includes a fixing rod 520 (which can be selectively provided according to actual requirements), the fixing rod 520 is fixed to the rear of the backrest 130, and the limiting member 510 is pivotally connected to the fixing rod 520.

The limiting member 510 includes a limiting portion 511, and the limiting member 510 can rotate in a direction approaching to the backrest 130, to press the seat belt 200 against the rear of the backrest 130 through the limiting portion 511. In this way, by rotating the limiting member 510 in the direction approaching to the backrest 130, the seat belt 200 can be pressed against the rear of the backrest 130 by the limiting portion 511, so as to prevent the portion of the seat belt 200 in the seating space 110 from being lengthened when an accident occurs, thereby reducing the degree of upward displacement of the child's head. In this embodiment, the limiting portion 511 includes a plurality of limiting teeth 511a. When the limiting member 510 rotates in the direction approaching to the backrest 130, the limiting teeth 511a abuts the seat belt 200 against the rear of the backrest 130, and a greater friction force can be generated between the limiting teeth 511a and the seat belt 200, thereby producing a better limiting effect. When it is necessary to adjust the length of the seat belt 200 in the seating space 110 according to the size of the child in the seating space 110, the limiting member 510 may be rotated in a direction away from the backrest 130, so as to release the abutment of the limiting portion 511 against the seat belt 200, thereby facilitating the adjustment of the length of the seat belt 200 in the seating space 110.

In this embodiment, as shown in FIGS. 2 and 10, the limiting member 510 includes a limiting body 512 having a substantially U-shaped structure and a limiting portion 511 disposed on a middle portion of the limiting body 512. Two ends of the limiting body 512 form pivoting portions 512a to be pivotally connected with the first barrier 300 or the fixing rod 520. Of course, in other embodiments, the limiting member 510 may also have other forms.

Further, as shown in FIGS. 1 and 2, the backrest 130 has a perforation hole 131, the second end 212 of the seat belt 200 passes around the front of the backrest 130 from the rear of the backrest 130 through the perforation hole 131, that is, enters into the seating space 110. The fixing rod 520 is arranged opposite to the perforation hole 131. In this way, the seat belt 200 can be well limited and fixed. In this embodiment, two perforation holes 131 are arranged and spaced apart from each other along the transverse direction of the backrest 130 and for the first shoulder belt 201 and the second shoulder belt 202 to pass through, respectively. Correspondingly, two limiting members 510 are arranged to abut the first shoulder belt 201 and the second shoulder belt 202 against the rear of the backrest 130, respectively.

Further, as shown in FIG. 1 and FIG. 2, the vehicle includes an on-board safety belt 20, and the on-board safety belt 20 is adapted to pass through the front of the backrest 130 to secure the child safety seat 10 to the vehicle. The second barrier 600 is fixed to the backrest 130 and is configured to prevent the backrest 130 from being deformed. The child safety seat 10 is fixed to the vehicle through the on-board safety belt 20, and the second barrier 600 fixed to the backrest 130 can prevent the backrest 130 from being deformed, so that it can be avoided that, when the vehicle encounters an accident such as an impact or an emergency braking, the backrest 130 is deformed (for example, the transverse dimension becomes smaller) under the pulling action of the on-board safety belt 20, causing the fixing of the on-board safety belt 20 to the child safety seat 10 becoming loose, thereby preventing the child safety seat 10 from being displaced, and reducing the degree of upward displacement of the child's head.

Further, as shown in FIG. 1 and FIG. 2, the on-board safety belt 20 is used to transversely pass through the front of the backrest 130, and the second barrier 600 is transversely disposed on the rear of the backrest 130. A specific mounting manner of the second barrier 600 may be as follows: a first mounting rib 132 and a second mounting rib 133 are arranged at intervals in the transverse direction on the rear of the backrest 130, and two ends of the second barrier 600 are fixed to the first mounting rib 132 and the second mounting rib 133, respectively. In this way, the second barrier 600 can serve to prevent the backrest 130 from being deformed, and prevent the on-board safety belt 20 from becoming loose. Of course, the second barrier 600 may also be fixed to the rear of the backrest 130 by other manners. For example, the second barrier 600 may be completely embedded or partially embedded in the rear of the backrest 130.

In this embodiment, as shown in FIG. 2 and FIG. 11, the second barrier 600 preferably has a circular tubular structure, which is simple in structure and convenient to manufacture. Optionally, the circular tubular structure has an outer diameter of 12 mm to 13 mm, and the circular tubular structure has a thickness of 1 mm to 1.6 mm. In this embodiment, the circular tubular structure has an outer diameter of 12.7 mm, and the circular tubular structure has a thickness of 1.5 mm. However, it is not limited to a circular tube, and the second barrier 600 may also be a square tube.

Further, as shown in FIG. 1, a clamping member 700 is disposed on the front of the backrest 130, and is configured to clamp and fix an on-board safety belt 20. In this way, the limiting and fixing effects of the clamping member 700 on the on-board safety belt 20 can be enhanced.

### Second Embodiment

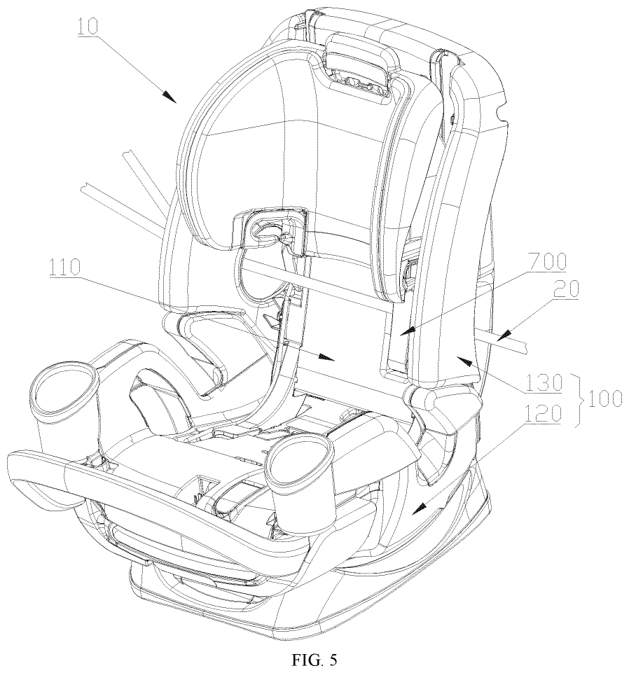

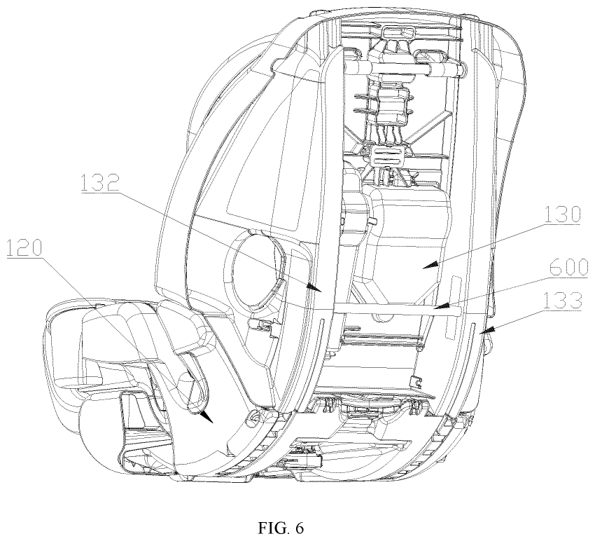

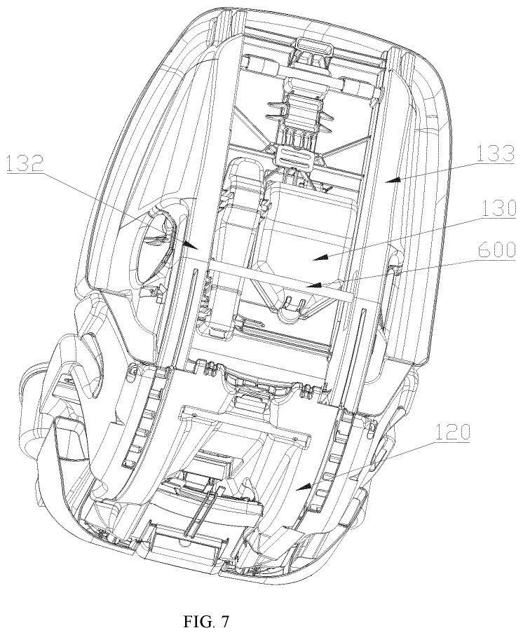

The second embodiment of the present application provides a child safety seat 10, which includes a seat body 100, a second barrier 600, and a clamping member 700. As shown in FIGS. 5 to 7, the child safety seat according to the second embodiment has substantially the same structure as the child safety seat according to the first embodiment, except that the seat belt 200, the first barrier 300, the limiting member 510, and the fixing rod 520 are omitted.

### Third Embodiment

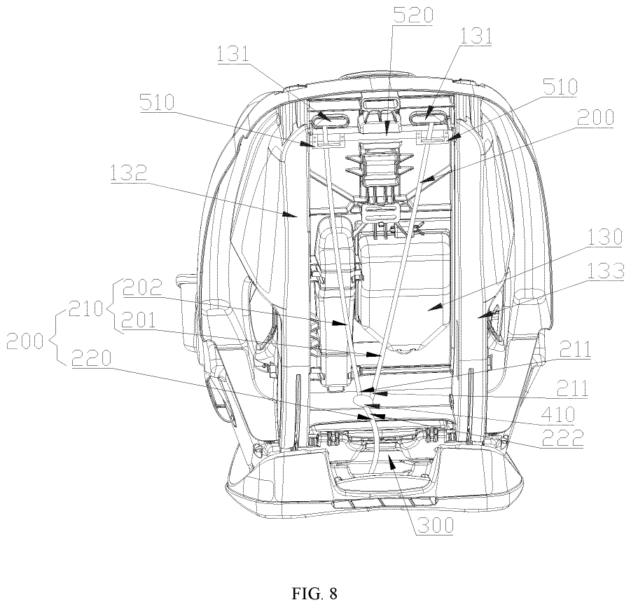

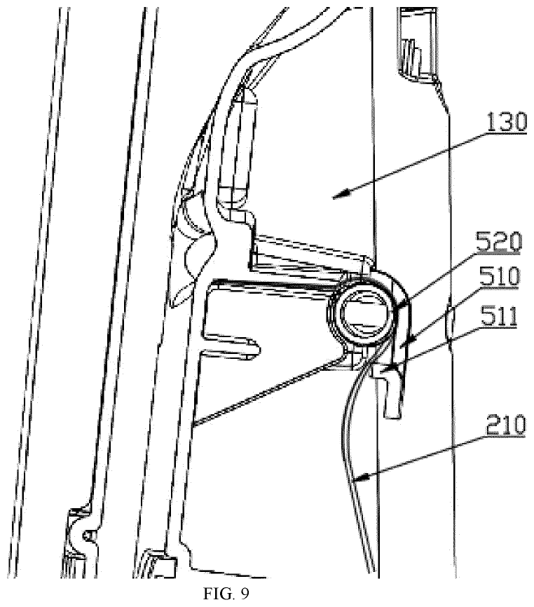

The third embodiment of the present application provides a child safety seat 10, which includes a seat body 100, a seat belt 200, a limiting member 510, and a fixing rod 520. As shown in FIGS. 1, 2, and 8 to 10, the child safety seat according to the third embodiment has substantially the same structure as the child safety seat according to the first embodiment, except that the first barrier 300, the second barrier 600, and the clamping member 700 are omitted.

### Fourth Embodiment

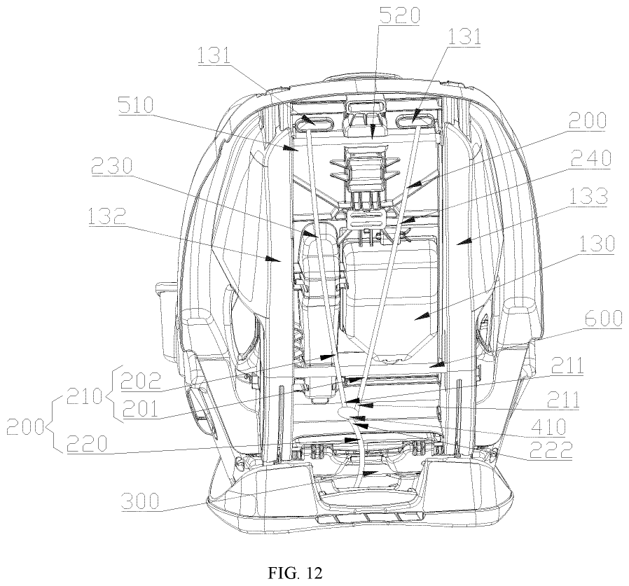

The fourth embodiment of the present application provides a child safety seat 10, which includes a seat body 100, a seat belt 200, a first barrier 300, a second barrier 600, and a clamping member 700. As shown in FIGS. 1 and 12, the child safety seat according to the fourth embodiment has substantially the same structure as the child safety seat according to the first embodiment, except that the limiting member 510 and the fixing rod 520 are omitted.

The above-described child safety seats 10 have at least the following technical effects.

In the above-described child safety seat 10, the seat belt 200 is wound around the front of the seat body 100 and the rear of the seat body 100 to secure the child in the seating space 10. In addition, the first barrier 300 is disposed on the rear of the seat body 100, the seat belt 200 abuts against the first barrier 300, and the first barrier 300 can prevent the seat body 100 from being deformed. In this way, it can be avoided that, when a vehicle is in an accident such as an impact or an emergency braking, the seat body 100 is pulled and dragged under the impact force of the seat belt 200 to be deformed such that the length of the seat belt 200 in the seating space 110 is increased to allow the child's head to be displaced upward too much, thereby effectively reducing the injury to the child's body.

The technical features of the above-described embodiments can be combined arbitrarily. To simplify the description, not all possible combinations of the technical features in the above embodiments are described. However, all of the combinations of these technical features should be considered as being fallen within the scope of the present application, as long as such combinations do not contradict with each other.

The foregoing embodiments merely illustrate some embodiments of the present application, and descriptions thereof are relatively specific and detailed. However, it should not be understood as a limitation to the patent scope of the present application. It should be noted that, a person of ordinary skill in the art may further make some variations and improvements without departing from the concept of the present application, and the variations and improvements falls in the protection scope of the present application. Therefore, the protection scope of the present application shall be subject to the appended claims.

1. A child safety seat, comprising:
a seat body defining a seating space;
a seat belt disposed on the front of the seat body and on the rear of the seat body; and
a first barrier disposed on the rear of the seat body,
wherein the seat belt abuts against the first barrier, and the first barrier is configured to receive stress due to impact force applied to the seat belt to prevent the seat body from being deformed.

2. The child safety seat according to claim 1, wherein the seat body comprises a seat base and a backrest, the seat base and the backrest enclose to define the seating space, the seat belt is disposed on the front of the seat base and the backrest and on the rear of the seat base and the backrest.

3. The child safety seat according to claim 2, wherein the first barrier is disposed on the rear of the seat base to enable the seat belt to be spaced apart from the rear of the seat base.

4. The child safety seat according to claim 2, wherein the first barrier has a hardness greater than that of the seat base.

5. The child safety seat according to claim 2, wherein the first barrier has a shape of rod, and is at least partially embedded in the rear of the seat base.

6. The child safety seat according to claim 2, wherein the seat belt comprises a first connecting section and a second connecting section, wherein the first connecting section has a first end and a second end, the first end is disposed on the rear of the backrest, and the second end is disposed on the front of the backrest, wherein the second connecting section passes around the seat base and has a third end and a fourth end, the third end is disposed on the front of the seat base, and the fourth end is connected to the first end.

7. The child safety seat according to claim 2, further comprising:
a limiting member configured to limit and fix the seat belt to the rear of the backrest; and
a fixing rod fixed on the rear of the backrest, and having the limiting member pivotably connected thereto.

8. The child safety seat according to claim 7, wherein the limiting member comprises a limiting portion configured to press the seat belt against the rear of the backrest.

9. (canceled)

10. The child safety seat according to claim 7, wherein the backrest is provided with a perforation hole, the seat belt passes around the front of the backrest from the rear of the backrest through the perforation hole, and the fixing rod is arranged opposite to the perforation hole.

11. The child safety seat according to claim 2, further comprising a second barrier transversely disposed on the rear of the backrest and configured to prevent the child safety seat from being deformed.

12. The child safety seat according to claim 11, wherein the rear of the backrest is provided with a first mounting rib and a second mounting rib disposed on two opposite sides thereof, and two ends of the second barrier are fixed on the first mounting rib and the second mounting rib, respectively.

13. (canceled)

14. The child safety seat according to claim 11, wherein the second barrier has a circular tubular structure; and the circular tubular structure has an outer diameter of 12 mm to 13 mm, and the circular tubular structure has a thickness of 1 mm to 1.6 mm.

15. The child safety seat according to claim 11, further comprising a clamping member disposed on the front of the backrest and configured to clamp and fix an on-board safety belt of a vehicle.

16. The child safety seat according to claim 1, further comprising:
a limiting member pivotably connected to the first barrier and configured to limit the seat belt to the rear of the seat body.

17. A child safety seat, comprising:
a seat body including a seat base and a backrest connected to each other to define a seating space; and
a second barrier fixed on the backrest and configured to prevent the backrest from being deformed.

18. The child safety seat according to claim 17, wherein the second barrier is transversely disposed on the rear of the backrest.

19. The child safety seat according to claim 17, wherein the rear of the backrest is provided with a first mounting rib and a second mounting rib disposed on two opposite sides thereof, and two ends of the second barrier are fixed on the first mounting rib and the second mounting rib, respectively.

20. (canceled)

21. (canceled)

22. The child safety seat according to claim 17, further comprising a clamping member disposed on a side of the backrest facing the seating space and configured to clamp and fix an on-board safety belt of a vehicle.

23. The child safety seat according to claim 2, wherein the first barrier is disposed on the rear of the backrest.

24. The child safety seat according to claim 17, wherein the backrest is provided with perforation holes on both sides thereof, the perforation holes are configured to allow an on-board safety belt of a vehicle to transversely pass through the front of the backrest, to fix the child safety seat to the vehicle;
wherein the second barrier is arranged closer to the perforation holes, to prevent the on-board safety belt from causing the backrest to be deformed.
